(19) United States
(12) Patent Application Publication
(10) Pub. No.: US 2020/0253821 A1
(43) Pub. Date: Aug. 13, 2020

(54) Facial Steaming Apparatus with a Rotating Nozzle

(71) Applicant: NVision Electrical Appliance Co., LTD, Nantong, Jiangsu Province: (CN)

(72) Inventor: Fei Jiang, Nantong, Jiangsu Province (CN)

(21) Appl. No.: 16/609,370

(22) PCT Filed: Jul. 20, 2018
(86) PCT No.: PCT/CN2018/096369

§ 371 Date: Oct. 29, 2019

(30) Foreign Application Priority Data
Jun. 1, 2018 (CN) 201810558127.3

(51) Int. Cl. A61H 33/12; B05B 3/02

(52) U.S. Cl. CPC A61H 33/12; A61H 2201/12; B05B 3/02

(57) ABSTRACT

The present invention is applicable to the field of cosmetic instruments. The present invention discloses a nozzle rotating mechanism and a facial steaming apparatus, wherein the nozzle rotating mechanism comprises a nozzle and a driving mechanism for rotating the nozzle, the nozzle being located outside an axis of a nozzle shaft, the axis of the nozzle being parallel to or forming an angle with the nozzle shaft. The nozzle rotating mechanism is driven to rotate by a driving mechanism when it is in use. Since the axis of the nozzle is parallel to or forming an angle with the nozzle shaft, i.e., the axis of the nozzle and the nozzle shaft are not on the same line, so the nozzle must form a larger radius of rotation relative to the axis of the nozzle shaft when the nozzle rotates on the nozzle shaft. Therefore, the nozzle can form a larger area, which can increase the area of steam injection, better suit requirements from different users, and improve the user experience. At the same time, the structure is simple, compact, stable and reliable. The nozzle rotating mechanism is widely used in steam cleaning devices for facial steaming apparatuses.

### FIELD OF TECHNOLOGY

The present invention relates to the field of cosmetic instruments, in particular, to a nozzle rotating mechanism and a facial steaming apparatus for beauty of a face by steam.

### BACKGROUND

For the existing cosmetic face steaming instrument, when it is used, due to factors such as the height of each user, the instrument is required to move or the user has to adapt to the movement of the instrument's position after the face steamer is placed.

For example, a fragrant rotary face steamer is disclosed in the patent document with the publication number of CN105943363A, wherein the nozzle is driven by a driving mechanism, which can directly rotate the nozzle of a specific structure directly. Although the fragrance rotary face steamer can increase the area of the fragrance steam spraying, the structure is complicated.

### SUMMARY

The technical problem mainly solved by the present invention is to provide a nozzle rotating mechanism and a facial steaming apparatus, wherein the rotating mechanism has a simple structure, is stable and reliable.

### TECHNICAL SOLUTION

In order to solve above technical problem, the present invention provides a nozzle rotating mechanism and a facial steaming apparatus, wherein the nozzle rotating mechanism comprises a nozzle and a driving mechanism for rotating the nozzle, the nozzle being located outside an axis of a nozzle shaft, the axis of the nozzle where the nozzle is located being parallel to or forming an angle with the axis of the nozzle shaft.

Further, an angle between the nozzle axis and the nozzle shaft is between 0-90 degrees.

Further, the driving mechanism includes a drive motor, a steam box guiding a steam to the nozzle, and a transmission component; the steam box includes a box body and a box cover rotatably connected with the box body to form a closed cavity, and the box body and the box cover are in communication with a steam generator and the nozzle through a steam inlet and a steam outlet, respectively; the transmission component includes a main gear connected to a shaft of the drive motor and a slave gear disposed on the box cover to be engaged with the main gear, and when the box cover is driven to rotate, the nozzle shaft is parallel to the nozzle.

Further, the driving mechanism includes a drive motor, a steam box rotationally connected to the steam generator, and a transmission component; the steam box is respectively provided with a steam inlet communicating with the steam generator and a steam outlet communicating with the nozzle on the upper and lower sides; the transmission component includes a main gear connected to the shaft of the drive motor and a slave gear disposed on an outer side of the steam box to be engaged with the main gear, and when the box cover is driven to rotate, the nozzle shaft is parallel to the nozzle.

Further, the steam box is arranged in a cylindrical shape, and the nozzle shaft and a physical axis of the cylindrical steam box are on the same line.

Further, the driving mechanism includes a drive motor, and a turntable connected to the shaft of the drive motor; an outer side of an axis of a shaft of the turntable is provided with a steam outlet, and the steam outlet is respectively connected to one end of a steam pipe and the nozzle; the other end of the steam pipe is rotatably connected to the steam generator, and a shaft of the steam pipe and the shaft of the turntable are on the same line.

Further, the nozzle is in an active connection with the steam outlet.

The present invention further provides a facial steaming apparatus, comprising a water tank, a steam generator communicating with the water tank, a steam pipe conveying the steam, a nozzle guiding the steam to the outside of a casing, and a nozzle rotating mechanism for rotating the nozzle, the nozzle rotating mechanism including a nozzle and a driving mechanism for rotating the nozzle; the nozzle is located outside an axis of a nozzle shaft, and the nozzle axis where the nozzle is located is parallel to or forms an angle with the axis of the nozzle shaft.

Further, an angle between the nozzle and the nozzle shaft is between 0-90 degrees.

Further, the driving mechanism includes a drive motor, a steam box guiding a steam to the nozzle, and a transmission component; the steam box includes a box body and a box cover rotatably connected with the box body to form a closed cavity, and the box body and the box cover are in communication with a steam generator and the nozzle through a steam inlet and a steam outlet, respectively; the transmission component includes a main gear connected to a shaft of the drive motor and a slave gear disposed on the box cover to be engaged with the main gear, and when the box cover is driven to rotate, the nozzle shaft is parallel to the nozzle.

Further, the driving mechanism includes a drive motor, a steam box rotationally connected to the steam generator, and a transmission component; the steam box is respectively provided with a steam inlet communicating with the steam generator and a steam outlet communicating with the nozzle on the upper and lower sides; the transmission component includes a main gear connected to the shaft of the drive motor and a slave gear disposed on an outer side of the steam box to be engaged with the main gear, and when the box cover is driven to rotate, the nozzle shaft is parallel to the nozzle.

Further, the steam box is arranged in a cylindrical shape, and the nozzle shaft and a physical axis of the cylindrical steam box are on the same line.

Further, the driving mechanism includes a drive motor, and a turntable connected to the shaft of the drive motor; an outer side of a shaft of the turntable is provided with a steam outlet, and the steam outlet is respectively connected to one end of a steam pipe and the nozzle; the other end of the steam pipe is rotatably connected to the steam generator, and a shaft of the steam pipe and the shaft of the turntable are on the same line.

Further, the nozzle is in an active connection with the steam outlet.

### BENEFIT OF THE INVENTION

The nozzle rotating mechanism of the present invention comprises a nozzle and a driving mechanism for rotating the nozzle, wherein the nozzle is located outside an axis of a nozzle shaft, and an axis of the nozzle is parallel to or forms an angle with the nozzle shaft. The nozzle rotating mechanism is driven to rotate by a driving mechanism when it is in use. Since the axis of the nozzle is parallel to or forming an angle with the nozzle shaft, i.e., the axis of the nozzle and the nozzle shaft are not on the same line, so the nozzle must form a larger radius of rotation relative to the axis of the nozzle shaft when the nozzle rotates on the nozzle shaft. Therefore, the nozzle can form a larger area, which can increase the area of steam injection, better suit requirements from different users, and improve the user experience. At the same time, the structure is simple, compact, stable and reliable. The nozzle rotating mechanism is widely used in steam cleaning devices for facial steaming apparatuses.

### BRIEF DESCRIPTION OF THE DRAWINGS

In order to illustrate the technical schemes in the embodiments of the present invention or in the prior art more clearly, the drawings which are required to be used in the description of the embodiments or the prior art are briefly described below. It is obvious that the drawings described below are some embodiments of the present invention. It is apparent to those of ordinary skill in the art that other drawings may be obtained based on the accompanying drawings without inventive effort.

The invention will be further described in detail in combination with drawings and the specific embodiments.

FIG. 1 is a cross-sectional view showing the structure of a first embodiment of a nozzle rotating mechanism along a plane direction composed of a nozzle shaft and a nozzle axis.

FIG. 2 is a cross-sectional view showing the structure of a second embodiment of the nozzle structure of FIG. 1.

FIG. 3 is a cross-sectional view showing the structure of a third embodiment of the nozzle structure of FIG. 1.

FIG. 4 is a cross-sectional view showing the structure of a second embodiment of a nozzle rotating mechanism along a plane direction composed of a nozzle shaft and a nozzle axis.

FIG. 5 is a cross-sectional view showing the structure of a second embodiment of the nozzle structure of FIG. 4.

FIG. 6 is a cross-sectional view showing the structure of a third embodiment of the nozzle structure of FIG. 4.

FIG. 7 is a cross-sectional view showing the structure of a third embodiment of a nozzle rotating mechanism along a plane direction composed of a nozzle shaft and a nozzle axis.

FIG. 8 is a cross-sectional view showing the structure of a second embodiment of the nozzle structure of FIG. 7.

FIG. 9 is a cross-sectional view showing the structure of a third embodiment of the nozzle structure of FIG. 7.

The implementation, functional features and advantages of the purpose of the present invention will be further described below in conjunction with the embodiments and with reference to the accompanying drawings.

### DESCRIPTION OF THE EMBODIMENTS

In order to make objectives, technical solutions, and advantages of the present invention clearer, the technical solutions in the present invention are described clearly and completely in the following with reference to accompanying drawings in the embodiments of the present invention. Apparently, the described embodiments are only part rather than all of the embodiments of the present invention. All the other embodiments obtained on the basis of the embodiments in this invention by those in the art without creative labor fall within the protection scope of this invention.

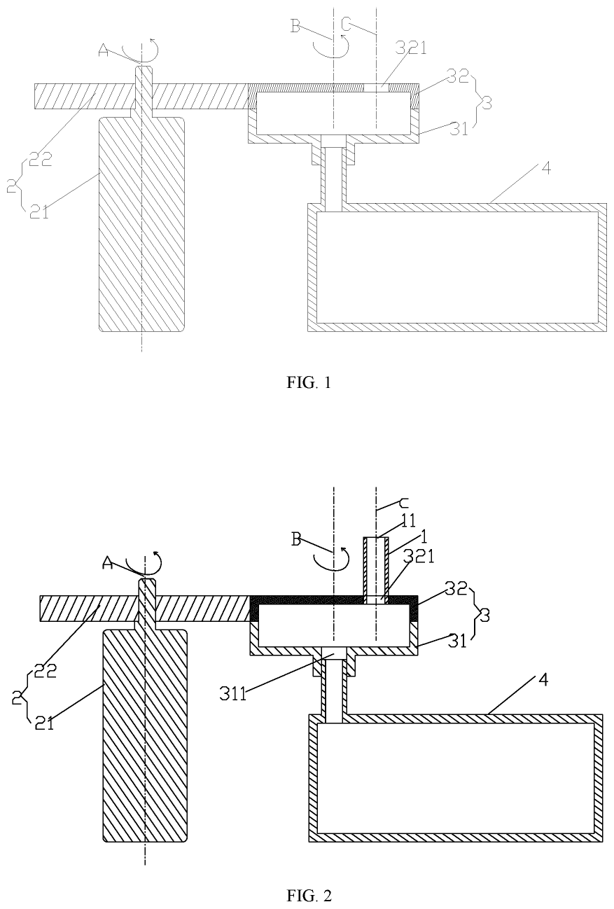

As shown in FIG. 1, the present invention provides an embodiment of a nozzle rotating mechanism.

The nozzle rotating mechanism comprises a nozzle and a driving mechanism 2 for rotating the nozzle, wherein a steam outlet 321 in communication with the nozzle is located outside an axis of a nozzle shaft B, and the nozzle is parallel to or forms an angle with the nozzle shaft.

Specifically, the nozzle rotating mechanism is used for a facial steaming apparatus. The nozzle shaft refers to a rotating shaft when the nozzle rotates periodically or reciprocally. The nozzle refers to a structure that may guide steam to the outside to facilitate contact of steam with the face, which may be a tubular structure or the steam outlet 321. In the present embodiment, the steam outlet 321 is used as the nozzle, and at this time, the steam outlet 321 and the nozzle are one component, that is, the steam outlet 321 and the nozzle are combined into one, the steam outlet 321 being usually circular in cross section, so as to describe the specific structure and working process of the nozzle rotating mechanism.

The steam outlet 321 is located outside the axis of the nozzle shaft B, and the axis C where the steam outlet 321 is located and the axis of the nozzle shaft B are on different lines.

The driving mechanism 2 includes a drive motor 21, a steam box 3 buffering the steam to guide to the steam outlet 321, and a transmission component driving the steam outlet 321 on the steam box 3 to rotate. The steam box 3 includes a box body 31 and a box cover 31 rotatably connected to the box body 31 to form a closed cavity. Through a steam inlet 311 on the box body 31, the steam box 3 realizes the steam outlet 321 of the box cover 32 to communicate with a steam generator 4. The steam box 3 may buffer the steam generated by the steam generator 4 and allow the steam to be continuously and uniformly discharged from the steam outlet 321. When the steam generated by the steam generator 4 is a hot steam, the steam is prevented from scalding the user. The steam generator 4 employs the prior art and may generate either a hot steam or a cold steam, as desired.

The transmission component may adopt the prior art, as long as the steam outlet 321 may be rotated along one shaft. The shaft may be a motor shaft, or may be parallel to or form an angle with the motor shaft. The transmission component may be a combination of a transmission belt and a transmission wheel, a combination of a turbine and a vortex rod, or a planetary gear structure. The transmission component of the present embodiment is driven by a gear, i.e. it includes a main gear 22 connected to a shaft of the drive motor 21 and a slave gear (not shown) disposed on the box cover 32 to be engaged with the main gear 22. When the box cover 32 is driven to rotate, the steam outlet 321 rotates along the nozzle shaft B, and the axis C where the steam outlet 321 is located is parallel to the nozzle shaft B.

In use, the drive motor 21 drives the main gear 22 to rotate by the motor shaft A, which drives the slave gear engaged with the main gear 22 for transmission to rotate, and the slave gear is fixedly connected to the box cover 32, so that the box cover 32 is rotated by the box body 31 as the shaft. When the steam box 3 is formed in a cylindrical shape, the nozzle shaft B coincides with the shaft of the box body 31, that is, the nozzle shaft B and a physical axis of the steam box 3 are in the same line. The box cover 32 has a cylindrical box body 31 as the shaft of the steam outlet 321, that is, the steam outlet 321 is rotated by the nozzle shaft B. Since an axis C where the steam outlet 321 is located and the nozzle shaft B are not on the same line, the steam outlet 321 is located outside the axis of the nozzle shaft. In other words, the axis C where the steam outlet 321 is located and the axis of the shaft of the steam outlet are not on the same line, and the steam outlet 321 is located outside the axis of the shaft of the steam outlet. When the steam outlet 321 is rotated by the nozzle shaft B, the steam outlet 321 must form a larger rotating radius of rotation relative to the axis of the nozzle shaft B. Therefore, the nozzle may form a larger area, which may increase the area of steam injection, and be better suit requirements from different users. At the same time, the structure is simple, compact, stable and reliable.

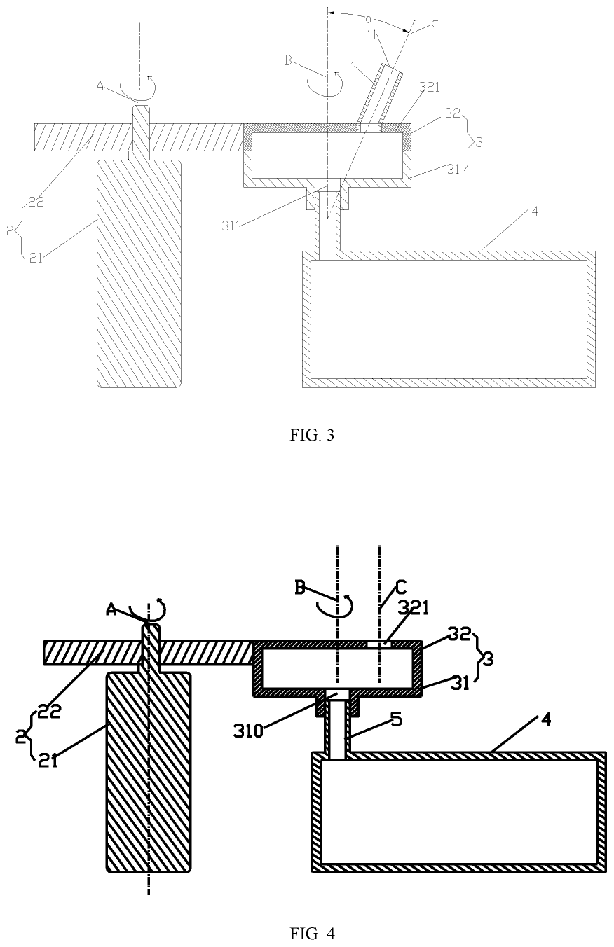

As shown in FIG. 2, on the basis of above embodiment, the present invention further provides a second embodiment of the nozzle structure. The steam outlet 321 and a steam vent 11 are of a separate structure. A nozzle pipe 1 having one end connected to the steam box 3 is provided at the steam outlet 321, and the other end of the nozzle pipe 1 is located outside the box cover 32, that is, the nozzle 11 is located outside the box cover 32. At this time, the nozzle shaft C where the nozzle pipe 1 is located is arranged in parallel with the nozzle shaft B, which similarly achieves a large steam injection area when rotating, better adapt to different user needs and improve user experience. The working principle is the same as that of the above embodiment, and details are not described herein.

As shown in FIG. 3, on the basis of above embodiment, the present invention further provides a third embodiment of the nozzle structure. The nozzle pipe 1 is disposed in an inclined structure, that is, a certain angle a is arranged between the nozzle axis C and the nozzle shaft B, so that a vertical distance between the nozzle 11 and the nozzle shaft B is greater than a vertical distance between the steam outlet 321 and the nozzle shaft B. In this way, the nozzle 11 may also be rotated within a large radius to generate a steam effect over a wide range in the case where the spacing between the steam outlet 321 and the axis of the nozzle shaft B is sufficiently small. The certain angle a between the nozzle axis C and the nozzle shaft B is configured as needed, such as between 0-90 degrees, wherein when the angle is 0 degrees, the nozzle pipe axis C is parallel to the nozzle shaft B, which is the same as in the above embodiment. Therefore, the angle a in the present embodiment does not include two end points, and is preferably configured to 30 degrees, 45 degrees, 60 degrees or 75 degrees.

In the present embodiment, since there is a certain angle between the nozzle pipe 1 and the nozzle shaft B, the position of the nozzle 11 is less restricted, and the requirements for the diameter of the steam box 3 is smaller when the same steam injection area is obtained, so as to effectively utilize the internal configuration and arrangement of the product.

The nozzle pipe 1 is configured to be movably connected to the steam box 3 as needed, for example, an active connection is provided between one end of the nozzle 1 pipe and the steam outlet 321, so as to ensure communication between the nozzle 11 and the steam box 3, and achieve an adjustable angle between the nozzle pipe axis C and the nozzle shaft B, that is, the position of the nozzle 11 may be adjusted. In this way, the user may adjust the area of the steam injection according to actual needs, so as to better adapt to different needs, and allow better adaptability. The nozzle pipe 1 is preferably a universal joint structure, so that there may be a plurality of adjustment angles between the nozzle pipe 1 and the steam box 3, thereby increasing the degree of freedom for adjusting the nozzle 11.

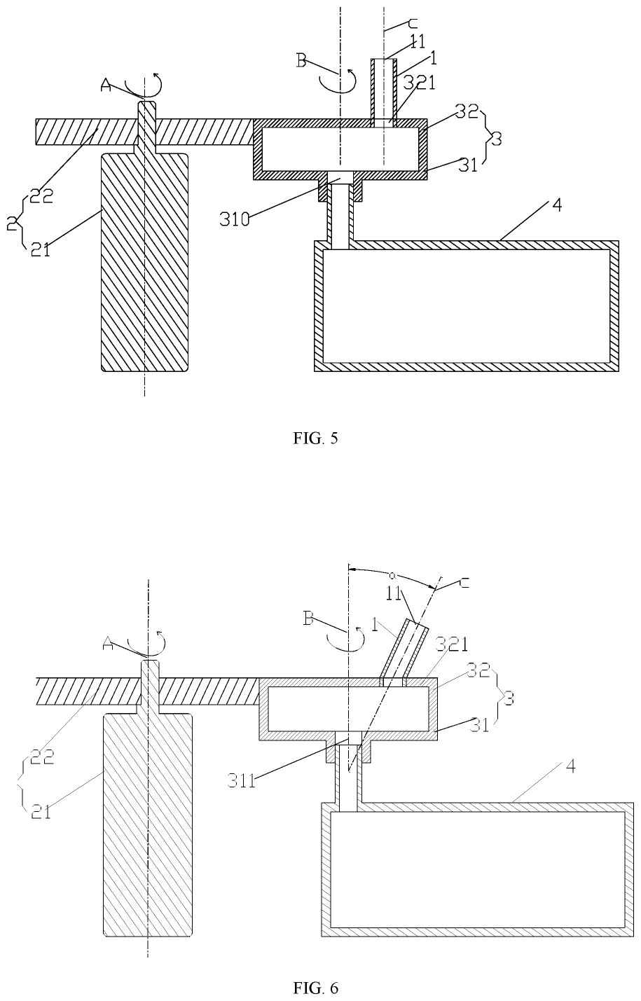

As shown in FIGS. 4 to 6, in above embodiment, the driving mechanism rotates the box cover 32 to drive an axis of the steam outlet or the nozzle pipe axis C disposed on the box cover 32 to be on a different line from the axis of the nozzle shaft B. The steam box 3 may also be integrally rotated by the driving of the transmission component as needed. At this time, the bottom of the steam box 3 is rotatably connected to the steam generator 4, for example, the steam box 3 is connected to the steam generator 4 through the steam pipe 5. One end of the steam pipe 5 connected to the steam box 3 is provided with a rotary bearing, and one end of the steam pipe 5 connected to the steam generator 4 is fixedly connected at one end. The steam inlet 310 on the steam box 3 is located at the axial center position of the steam box 3, and the axis of the nozzle shaft B and the axis of rotation of the steam box 3 and the axis of the steam pipe 5 are on the same line. At this time, the steam pipe 5 to which the steam generator 4 is connected maybe used as a shaft with the steam box 3, the steam pipe 5 being disposed at the bottom center position of the steam box 3. The working process and the structure of the nozzle are the same as those of the above embodiments, and may be referred to the description of the above embodiments, and will not be described again.

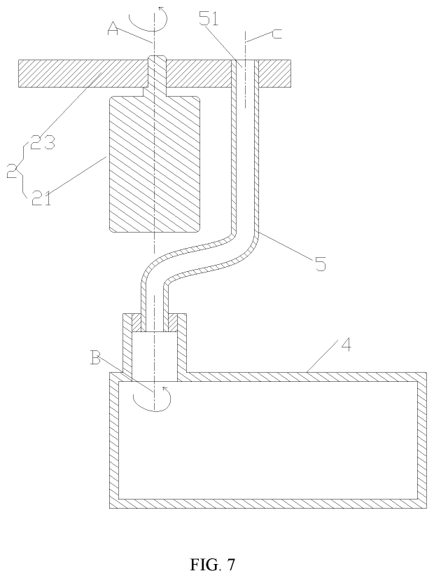

As shown in FIG. 7, on the basis of above embodiments, the present invention provides another embodiment of a nozzle rotating mechanism. Compared with above embodiments, in this nozzle rotating mechanism, the steam box 3 is omitted, the steam pipe 5 directly guides the steam to the turntable 23; the steam pipe 5 is fixed at one end to the turntable 23, and the other end thereof is in rotational communication with the steam generator 4.

Specifically, the nozzle is the steam outlet 51 of the steam pipe 5. The driving mechanism 2 includes a drive motor 21, and a turntable 23 connected to the shaft of the drive motor 21; an outer side of an axis of a shaft A of the turntable is provided with a steam outlet 51 as the nozzle, that is, one end of the steam pipe 5 is fixed with the turntable 23 and located outside the axis of the turntable shaft A, and the other end of the steam pipe 5 is rotatably connected to the steam generator 4; the shaft B of the steam pipe and the shaft A of the turntable are on the same line, and the turntable shaft A is coaxial with the motor shaft.

When in use, the motor drives the turntable 23 to rotate, the steam pipe 5 with one end away from the axis of the turntable shaft A rotates synchronously, and the other end of the steam pipe 5 rotates with the steam generator 4. Since the turntable shaft A and the steam pipe shaft B and the motor shaft are on the same line, the steam pipe 5 may be caused to smoothly rotate. And, since the steam outlet 51 is away from the axis of the turntable shaft A, the steam outlet 51 may generate a large range of steam injection when the steam outlet 51 is rotated by the shaft A, thereby better adapting to different user needs and improving user experience.

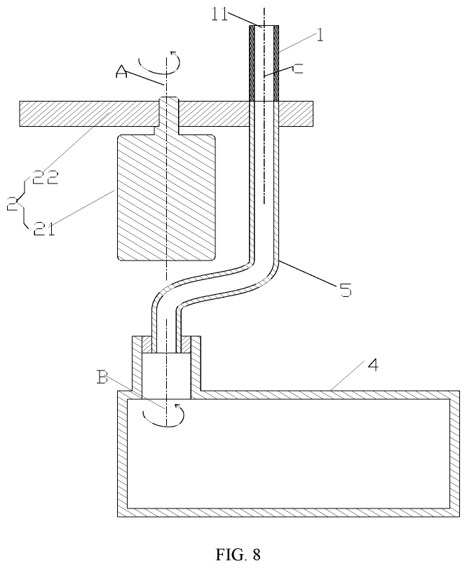

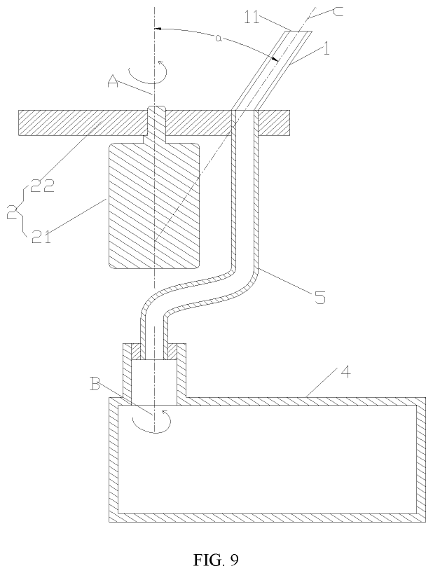

As shown in FIGS. 8 to 9, on the basis of above embodiments, the above technical effects may also be achieved by combining the nozzle structure of each embodiment with the structure shown in FIG. 7, and the working process is the same as that of this embodiment, which will not be described again.

The nozzle pipe 1 is configured to be movably connected to the steam box 3 as needed, for example, an active connection is provided between one end of the nozzle 1 pipe and the steam outlet 321, so as to ensure communication between the nozzle 11 and the steam box 3, and achieve an adjustable angle between the nozzle pipe axis C and the nozzle shaft B, that is, the position of the nozzle 11 may be adjusted. In this way, the user may adjust the area of the steam injection according to actual needs, so as to better adapt to different needs, and allow better adaptability. The nozzle pipe 1 is preferably a universal joint structure, so that there may be a plurality of adjustment angles between the nozzle pipe 1 and the steam box 3, thereby increasing the degree of freedom for adjusting the nozzle 11.

The structure of each of the nozzle rotating mechanism embodiments described above may be applicable to both a facial steaming instrument and a steam cleaning device.

The present invention further provides an embodiment in which the above nozzle rotating mechanism is applied to a facial steaming apparatus.

The facial apparatus comprises a water tank, a steam generator communicating with the water tank, a steam pipe conveying the steam, a nozzle guiding the steam to the outside of a casing, and a nozzle rotating mechanism for rotating the nozzle, and may further comprise a control module for controlling of the driving of the steam generator and the operation of the nozzle rotating mechanism. The nozzle rotating mechanism here adopts the above embodiments, with reference to the above specific description. The control module, the steam generator, and the like adopt the prior art, and details are not described herein again.

The facial steaming apparatus adopting the above nozzle rotating mechanism may also achieve the technical effects of a large range of steam injection, better adapting to different user needs, and improving the user experience.

The above embodiments are only used to illustrate the technical solutions of the present invention, and are not limited thereto. Despite reference to the aforementioned embodiments to make a detailed description of the present invention, those of ordinary skilled in the art should understand: the described technical solutions in above various embodiments may be modified or the part of technical features may be equivalently substituted; while these modifications or substitutions do not make the essence of their corresponding technical solutions deviate from the scope of the technical solutions of the embodiments of the present invention.

What is claimed is:

1. A nozzle rotating mechanism, comprising a nozzle and a driving mechanism for rotating the nozzle, characterized in that the nozzle is located outside an axis of a nozzle shaft, and the nozzle axis where the nozzle is located is parallel to or forms an angle with the axis of the nozzle shaft.

2. The nozzle rotating mechanism according to claim 1, characterized in that an angle between the nozzle axis and the nozzle shaft is between 0-90 degrees.

3. The nozzle rotating mechanism according to claim 1, characterized in that the driving mechanism includes a drive motor, a steam box guiding a steam to the nozzle, and a transmission component that; the steam box includes a box body and a box cover rotatably connected with the box body to form a closed cavity, and the box body and the box cover are in communication with a steam generator and the nozzle through a steam inlet and a steam outlet, respectively; the transmission component includes a main gear connected to a shaft of the drive motor and a slave gear disposed on the box cover to be engaged with the main gear, and when the box cover is driven to rotate, the nozzle shaft is parallel to the nozzle.

4. The nozzle rotating mechanism according to claim 1, characterized in that the driving mechanism includes a drive motor, a steam box rotationally connected to the steam generator, and a transmission component; the steam box is respectively provided with a steam inlet communicating with the steam generator and a steam outlet communicating with the nozzle on the upper and lower sides; the transmission component includes a main gear connected to the shaft of the drive motor and a slave gear disposed on an outer side of the steam box to be engaged with the main gear, and when the box cover is driven to rotate, the nozzle shaft is parallel to the nozzle.

5. The nozzle rotating mechanism according to claim 3, characterized in that the steam box is arranged in a cylindrical shape, and the nozzle shaft and a physical axis of the cylindrical steam box are on the same line.

6. The nozzle rotating mechanism according to claim 1, characterized in that the driving mechanism includes a drive motor, and a turntable connected to the shaft of the drive motor; an outer side of an axis of a shaft of the turntable is provided with a steam outlet, and the steam outlet is respectively connected to one end of a steam pipe and the nozzle; the other end of the steam pipe is rotatably connected to the steam generator, and a shaft of the steam pipe and the shaft of the turntable are on the same line.

7. The nozzle rotating mechanism according to claim 3, characterized in that the nozzle is in an active connection with the steam outlet.

8. A facial steaming apparatus, comprising a water tank, a steam generator communicating with the water tank, a steam pipe conveying the steam, a nozzle guiding the steam to the outside of a casing, and a nozzle rotating mechanism for rotating the nozzle, the nozzle rotating mechanism including a nozzle and a driving mechanism for rotating the nozzle, characterized in that the nozzle is located outside an axis of a nozzle shaft, and the nozzle axis where the nozzle is located is parallel to or forms an angle with the axis of the nozzle shaft.

9. The facial steaming apparatus according to claim 8, characterized in that an angle between the nozzle and the nozzle shaft is between 0-90 degrees.

10. The facial steaming apparatus according to claim 8, characterized in that the driving mechanism includes a drive motor, a steam box guiding a steam to the nozzle, and a transmission component; the steam box includes a box body and a box cover rotatably connected with the box body to form a closed cavity, and the box body and the box cover are connected to a steam generator and the nozzle through a steam inlet and a steam outlet, respectively; the transmission component includes a main gear connected to a shaft of the drive motor and a slave gear disposed on the box cover to be engaged with the main gear, and when the box cover is driven to rotate, the nozzle shaft is parallel to the nozzle.

11. The facial steaming apparatus according to claim 8, characterized in that the driving mechanism includes a drive motor, a steam box rotationally connected to the steam generator, and a transmission component; the steam box is respectively provided with a steam inlet communicating with the steam generator and a steam outlet communicating with the nozzle on the upper and lower sides; the transmission component includes a main gear connected to the shaft of the drive motor and a slave gear disposed on an outer side of the steam box to be engaged with the main gear, and when the box cover is driven to rotate, the nozzle shaft is parallel to the nozzle.

12. The facial steaming apparatus according to claim 10, characterized in that the steam box is arranged in a cylindrical shape, and the nozzle shaft and a physical axis of the cylindrical steam box are on the same line.

13. The facial steaming apparatus according to claim 8, characterized in that the driving mechanism includes a drive motor, and a turntable connected to the shaft of the drive motor; an outer side of a shaft of the turntable is provided with a steam outlet, and the steam outlet is respectively connected to one end of a steam pipe and the nozzle; the other end of the steam pipe is rotatably connected to the steam generator, and a shaft of the steam pipe and the shaft of the turntable are on the same line.

14. The nozzle rotating mechanism according to claim 10, characterized in that the nozzle is in an active connection with the steam outlet.
